(19) United States
(12) Patent Application Publication
(10) Pub. No.: US 2014/0019558 A1
(43) Pub. Date: Jan. 16, 2014

(54) SYSTEM AND METHOD OF SHORT DOMAIN NAMES USED FOR REMAILING TO APPLY COMPUTATIONS TO EMAIL EN ROUTE AND ENABLE PRIVATE SHARING OF FILES STORED IN THE CLOUD

(71) Applicant: Jordan Pollack, Sudbury, MA (US)

(72) Inventor: Jordan Pollack, Sudbury, MA (US)

(73) Assignee: Thinmail, Sudbury, MA (US)

(21) Appl. No.: 13/547,325

(22) Filed: Jul. 12, 2012

(51) Int. Cl. G06F 15/16

(52) U.S. Cl. 709/206

(57) ABSTRACT

A system and a process for performing identified modifications of content in an e-mail message at a server or server farm electronically distal from an e-mail origin site. The process acts so that:
a) the distal server or server farm pointed to by an MX record of a short domain in the domain name server system; and
b) an e-mail message comprising a recipient e-mail address combined with said short domain as a suffix.

### BACKGROUND OF THE INVENTION

### Field of the Invention

In the field of online or cloud storage, users may upload files to a server or server farm on the internet by various means. The earliest method was command-line based using such protocols as File Transfer Protocol (FTP) and lately Secure Copy Protocol (SCP). Subsequently, uploading methods include but are not limited to emailing an attachment to a specific address at the server (Email-to-FTP) and using web “forms” under the Common Gateway Interface (CGI) protocol with a text box into which one can type the path to a file, as well as a browse button to select a file from the local machine's tree-like file system before hitting a submit button to upload the file. The most ergonomic way is to use a so-called “Drag and Drop” method in which an icon for the desired file is dragged into a folder or application to move the file or apply the application. This Drag and Drop has become so universal, that even the command line methods lie FTP and SCP use it, e.g. FTPXplorer and WINScp. Other elaborations of Drag and Drop include making the receiving folder look like a native folder on the local machine, but the files inside that folder are uploaded and downloaded to the cloud server to provide a “synchronize” functionality and redundancy in case of disk failure.

In our U.S. Pat. No. 6,505,236 of an idea reduced to practice in 1999, we teach how to use remailing to mount into online storage those files sent and received as email attachments. There, the server “thins” the email by caching the attachment in the cloud and replacing the attachment with a private file handle, which may look like a Uniform Resource Location (URL). In this document “Private” refers to a file stored in an online server which requires a password to view, so that promiscuous sharing of that file cannot occur without violating one's own privacy.

A model called GMAIL-DRIVE was released in 2005, which used the drag and drop interface to store files inside of Google's gmail application, which offered users free storage of several gigabytes. This “business model”—of giving out large chunks of disk storage for free and then turning users into customers—has expanded, with many competitive offerings from both large and small companies. This includes Google, Microsoft, Dropbox, and Box.net. Some online storage sites which allow uploads by drag and drop, like Megadownload, have become havens for piracy because they allow the links to be published.

Besides interfaces on desktop and laptop personal computers, these cloud services also offer “apps” to interface to your online files from mobile devices like PDA's, tablets, and so-called “smart” phones, enabling a user to preview and forward files through both office WI-FI and commercial wireless networks.

We note that providers of free web mail services such as Hotmail, Yahoo, and Gmail, are now working to link their webmail service with their online storage offerings, perhaps to share customers or make accessing their files easier than searching though thousands of email messages.

How may files in the cloud be shared with others? Some services are run using privacy by obscurity where simply holding the URL provides one access to the file. Others, with elaborate interfaces, can provide a “view” button or a button which copies a URL link into the local-machine's clipboard to be pasted into e.g. an email message. Google Docs provides a pop-up “share” screen which has at least 4 schemes for sharing, by link, by individual rights, by group, or fully public.

### SUMMARY OF THE INVENTION

The subject of this patent is the use of a short domain for remailing messages. A short domain comprises a 2 or 3 character Top-level domain (TLD) prefixed by a 2 or 3 character Second-level domain (SLD). The TLD may be a usual form of .com or .org or a national 2-letter TLD such as .TO or .IO. Each TLD organization places constraints on the secondary domains, both the ones they allow and on who may own them. Thus the space of short domains includes 1 letter SLDs at .co (Columbia), but only 3 letter SLD's in .BO (Bolivia).

Our use of a short domain directs its MX record to a server in the cloud which is then able to perform arbitrary computations on the email messages en-route between the source server and the recipient server This remailing technology may offer services such as Spam Protection, which is often done throughredirecting the Mail Exchanage (MX) record of the customer's domain, allowing the anti-spam company complete control of the receipt of mail for the customer.

This remailing technology may provide for Language Translation en route, using proprietary software or API's to such services as Google Translate.

This short-domain remailing technology may enable the private sharing of files stored online in a cloud-based file-system, which may have been uploaded using our '236 patent or any of the other uploading methods described above. Our invention enables the private sharing of files using simple email from any device, instead of an elaborate drag and drop interface. The email may be typed in by the user, or hidden behind a soft button which formats the message correctly. Thus, wherever a user has access to email, he can forward a recently received file from the cloud to another party without publishing the link or turning a private URL into a publically shared resource which increases the cost of providing cloud storage.

A service provider may provide both public and private links, where the user may share the private link with a third party, who is thus invited to join the service. But the third party may be able to further publish the link he received, thereby turning the private file into a public resource.

Thinmail, founded in 1999, solved this important problem in its “Beta” release to select customers. This resulted in 2002 application Ser. No. 09/905,432 recently abandoned. However the beta did not turn into a final product because the company was unable to raise the capital necessary to grow, nor did the '432 application disclose other features and trade-secrets, which are hereby claimed herein under 35 USC 102 despite the abandonment of '432.

Now, the recipient of an email under U.S. Pat. No. 6,505,236 has in hand a URL to the file stored on our file server in the cloud. Access to said file is under a “second access password protection” so his first download is convenient, but the second and thereafter access requires the user's password. This prevents the URL from being used as a vehicle for violating copyright, and preserves the intent of the sender of the file to share it via email. In order to allow such sharing, the user would have to publish his password, which is a violation of our Terms of Service.

Because Thinmail's interface was primarily through Email rather than having a modern graphical user interface, we had to solve the major problem of letting a user forward files to his colleagues without turning the file into a publically shared resource. In abandoned patent '432 we teach that with a combination of 3 elements within an email message to the server, various commands can be invoked to take place on the server involving those files owned by the user. These include, but are not limited to, faxing, phoning, fedexing, deleting, previewing, and translating. The three elements are (a) the sender's email address in the FROM: field, (b) the at least one valid file-handle (URL) in the body of the email, and (c) the command and optional parameters in the SUBJECT: or TO: field of the message.

An example of the combination of 3 elements is the faxing of a received document to a nearby fax machine. Here is one email message with the 3 components identified:

TO: fax@thinmail.com

FROM: john@aol.com

SUBJECT: 8005551212

http://www.thinmail.com/tm/98234sg/proposal.doc

The command is built into the TO field, the parameter for faxing is given in the SUBJECT, and the URL to the file is in the body of the email. Another message which provides the same thing is as follows:

TO: 8005551212@thinfax.com

Subject: For Joe at extension 35

http://www.thinmail.com/tm/98234sg/proposal.doc

Note that both the command and its parameter are coded into the recipient's dynamically generated email address.

The object of this invention is a process and method for sharing file-handles

(URL's) to private files stored on a storage system located in the internet cloud, from one user to another, where the privacy for each user is maintained. In the style of the faxing example above, we begin with a message with the 3 elements made explicit:

FROM: bill@microsoft.com

TO: Daemon@thinmail.com

SUBJECT: forward steve@apple.com

http://thinmail.com/tm/2893f/patent.pdf

The recipient is the TO: field, the user who owns the file is the FROM: field, the command and its parameter are in the SUBJECT: field, and the file to be forwarded is indicated by the URL in the body of the message. Other commands like faxing and text extraction had their own destination. So we could do this for forwarding as well

FROM: bill@microsoft.com

TO: forward@thinmail.com

SUBJECT: steve@apple.com

http://thinmail.com/tm/2893f/patent.pdf

Now the command is embedded by the name component of the destination email address, and the subject is the ultimate recipient. We also used an old form to make a “quotation” of the recipients name such as Steve % apple.com@thinmail.com where the recipient is part of the destination address on our server. During our beta testing period, we purchased a short domain like “TM.TO” to do a quotation of the recipient into the destination as follows:

FROM: bill@microsoft.com

TO: steve@apple.com.TM.TO

SUBJECT: FORWARD

http://thinmail.com/tm/2893f/patent.pdf

The user may add the short domain suffix to recipient address manually, or the mail application can add it to recipient address using a soft-button or macro. The three elements (from, command and parameter, handle) are still present. In fact, we discovered we could privately forward files on a cloud storage system without the third component at all. We can remove the command “FORWARD” because it is implicit in the message from the sender, and our server still performs the forwarding operation.

FROM: bill@microsoft.com

TO: steve@apple.com.TM.TO

http://thinmail.com/tm/2893f/patent.pdf

Because our server in the cloud is pointed to by the MX record of the short domain TM.TO by the DNS system, our server receives the {user, implicit command, parameter, and handle} and creates a new handle to the existing file and forwards that new handle to the recipient, thus solving the problem of private sharing of files in the cloud using a short domain. The DNS system or DNS server is any computer registered to join the Domain Name System. A DNS server runs special-purpose networking software, features a public IP address, and contains a database of network names and addresses for other Internet hosts. A mail exchanger record (MX record) is a type of resource record in the Domain Name System that specifies a mail server responsible for accepting email messages on behalf of a recipient's domain, and a preference value used to prioritize mail delivery if multiple mail servers are available. The set of MX records of a domain name specifies how email should be routed with the Simple Mail Transfer Protocol.

Even 10 years later, because Thinmail did not get out of beta, the use of a short domain to enable remailing has never been duplicated, and we claim that Thinmail pioneered this use of a short domain for remailing in other applications besides forwarding, such as spam filtering (usually accomplished by manipulating a corporate customer's MX record) and language translation en route.

To enable language translation en-route with a short domain suffix consider eng.fre.to to represent English to French service and fre.eng.to to represent French to

English service. John sends an English message to his French friend Henri as follows:

From: John@aol.com

To: Henri@gmail.fr.eng.fre.to

I hope using this service you will understand my email

The service pointed at by the short domain fre.to intercepts the email, translates the body and any attachments from English to French and forwards it on. It can also change the email of the sender so the reply goes through French-to-english translation:

From John@aol.com.fre.eng.to

To: Henri@gmail.fr

J'espère utiliser ce service, vous comprendrez mon e-mail

Now when Henri replies in french, the mail will be automatically translated into English.

Even 10 years later, because Thinmail never made it out of “Beta”, none of the large cloud storage software-as-a-service companies have implemented our processes and methods of privately sharing files using remailing through a short domain name, which would be very beneficial in customer acquisition as a viral strategy.

### BRIEF DESCRIPTION OF THE FIGURES

FIG. 1 shows an embodiment of a server on the internet cloud communicating with 3 clients.

FIG. 2 shows a screenshot of the traditional way to upload and download files from a cloud storage system using a local machine such as a PC 8 running a GUI version of FTP or SCP.

FIG. 3 shows the transformation of an email during transit from sender's viewpoint 20 to recipient's viewpoint 21.

FIG. 4 shows simplified SQL tables used by this invention.

FIG. 5 is a schematic diagram that assists in explaining the forwarding process and method in greater detail.

### DETAILED DESCRIPTION OF THE INVENTION

The foregoing and other objects, aspects, features, and advantages of the disclosure will become more apparent and better understood by referring to the following description taken in conjunction with the accompanying drawings.

The present technology includes a process, system, apparatus and software for enabling a process for performing identified modifications of content in an e-mail message at a server or server farm electronically distal from an e-mail origin site including:
a) the distal server or server farm recognizing presence of a short domain name as a suffix on an email address;
b) the distal server or server farm then executing code in response to the short domain name as a suffix;
c) the executed code specifically selected by the server or server farm in response specific to the short domain name as a suffix; and
d) the specific code executed performing a modification on content in the e-mail or an attachment to the e-mail.

The process modification may be performed en route between sending and delivering the e-mail. The process modification may be an arbitrary process performed by the server or server farm.

A server or serverfarm in the cloud may execute code on transported e-mails (that is, the original e-mail is preferably not generated at the server or server farm but is created and originally sent from an electronically distal processor or server) by executing code on remailing software (that is, once the original e-mail is received in transit and modification(s) performed thereon, it is sent again to an appropriate address) that creates new handles or new URL's for each recipient of messages originally containing valid URL's, the new handles or new URL's directing the transported e-mails to files stored in the server or serverfarm.

A system of short domain names used for remailing to apply computations to email en route including a receiving portal for receiving from a sender an electronic mail item which contains a user identification, and a file handle, a storage device containing a file corresponding to the file handle, a rights verifier for determining whether or not the sender has privilege to access the stored file corresponding to the file handle, which shares the rights to said file via a new file handle created for the recipient of the message.

The system of short domain names used for remailing to apply computations to email en route may include a file handle recognizer for locating conforming file handle patterns within the body of the electronic mail item, a user identification system which extracts information from the electronic mail item including the from address, destination address, the subject, the reply-to, and the body of the electronic mail item, to enable verification of the sender as a known user of the system.

The system of short domain names for remailing to apply computations to email en route used to forward email to a third party with a newly constructed file handle to the file stored on the storage device.

The system may include at least one of an optical character recognition device, automatic speech recognition device, language translation device, and a file format translation device associated with the computations to be applied to email en route. The file handle may be a uniform resource locator. The storage device may be chosen from the group consisting of hard drives, optical drives, random access memories, tape drives, RAID arrays, and storage area networks.

This invention also features a method for using short domain names in remailing to apply computations to email en route, including the steps of receiving from a sender an electronic mail item which contains an user identification, a file handle determining whether or not the sender has privilege to access the stored file corresponding to the file handle, applying the desired computation upon the file retrieved from the storage device when the sender is determined to have access rights to the file.

This invention also features a computer readable medium having a plurality of instructions stored thereon which, when executed by a processor, cause the processor to perfonn the steps of receiving from a sender an electronic mail item which contains an user identification, a file handle, determining whether or not the sender has privilege to access a file stored on a storage device corresponding to the file handle, retrieving the stored file from the storage device, and executing the appropriate computation upon the retrieved file when the sender is determined to have the access rights to said file.

The computer readable medium may be a hard drive, optical drive, Random Access Memory, Read Only Memory, or tape drive.

This invention also features a processor and memory configured to perform the steps of, receiving from a sender an electronic mail item which contains an user identification, a file handle, determining whether or not the sender has privilege to access a file stored on a storage device corresponding to the file handle, retrieving the stored file from the storage device, and executing the desired computation on the retrieved file when the sender is determined to have the access rights to the file.

The processor and memory may be incorporated into a personal computer, a programmable logic controller, a single board computer, or an array of network servers.

The system of short domain names used for remailing to apply computations to email en route may be implemented on a mainframe computer, a minicomputer, server device, a personal computer, a microcomputer, a handheld computer or a cluster of computers. The storage for files may be chosen from a group consisting of hard drives, optical drives, random access memories, tape drives, RAID arrays, Storage Area Networks, or network attached storage. The Rights verifier may be implemented as an expert system, a graph, a table, a spreadsheet, a list or tree, or as part of a relational database, the preferred embodiment for scaling information.

The desired computation may involve different subroutines and resources for each potential or actual application of the system and method, and may involve triggering changes in the network storage system itself, dispatching a program to run on a file, queueing a file to a perpetually running process, farming work to a network of computers running programs, outsourcing the file across the internet or telephone network via a third party provider.

### DESCRIPTIONS OF THE FIGURES

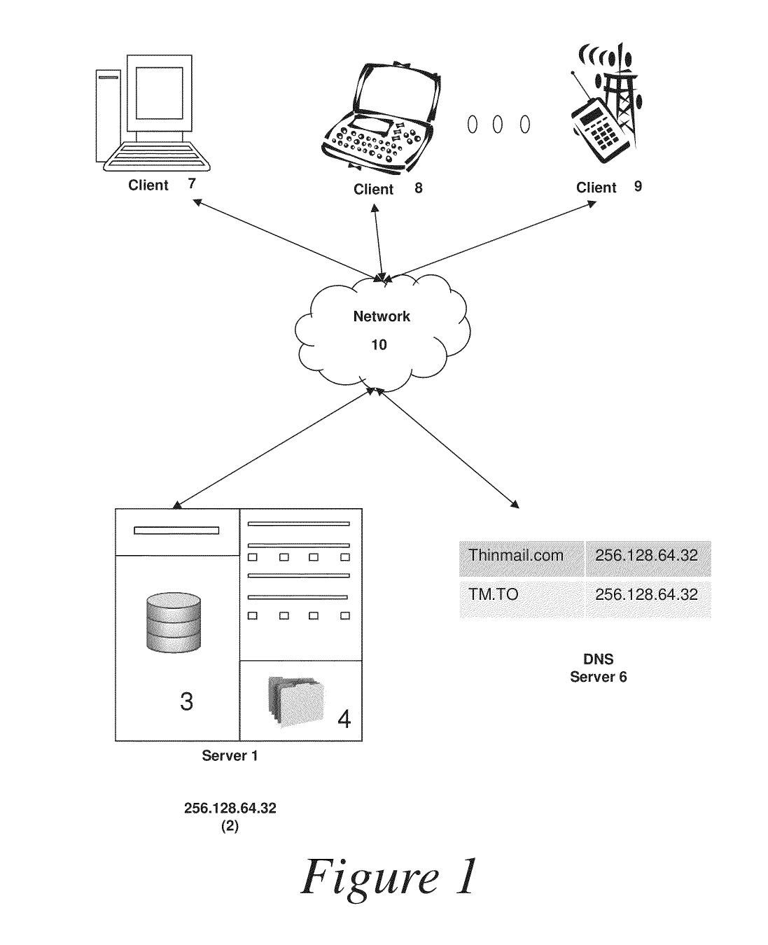

Referring now to FIG. 1, an embodiment of a server on the internet cloud communicating with 3 clients is depicted. In brief overview, the network environment comprises one or more clients 7-9 (also generally referred to as local machines in communication with one or more remote machines 1 (also generally referred to as servers via one or more networks 10.

Although FIG. 1 shows a network 10 between the clients 7-9 and the remote machines 1, the clients 7-9 and the remote machines 1 may be on the same network 10. The network 10 can be a local area network (LAN), such as a company Intranet, a metropolitan area network (MAN), or a wide area network (WAN), such as the Internet or the World Wide Web. In some embodiments, there are multiple networks 10 between the clients 7-9 and the remote machine 1. In one of these embodiments, a network 10 may be a private network and a network 10′ may be a public network. In another of these embodiments, a network 10 may be a private network and a network 10′ a public network. In still another embodiment, networks 10 and 10′ may both be private networks.

The network 10 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 10 may comprise a wireless link, such as an infrared channel or satellite band. The topology of the network 10 may be a bus, star, or ring network topology. The network 10 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 8 and a remote machine 1 (referred to generally as computing devices) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 7-9 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 7-9.

In one embodiment, a computing device 1 provides functionality of a web server. In some embodiments, a web server 1 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif. In further embodiments, a computing device 1 executes self-replication software. In one of these embodiments, execution of the self-replication software allows a computing device 1 to direct a second computing device 1b to provide a copy of data stored by the computing device 1. For example, the computing device 1a may provide access to a web site and, upon execution of the self-replication software, direct the second computing device 1b to provide access to a copy of the web site.

In some embodiments, the system may include multiple, logically-grouped remote machines 1. In one of these embodiments, the logical group of remote machines may be referred to as a server farm. In another of these embodiments, the server farm may be administered as a single entity.

Each computer program within the scope of the claims below may be implemented in any programming language, such as assembly language, machine language, a high-level procedural programming language, or an object-oriented programming language. The programming language may, for example, be LISP, PROLOG, PERL, PHP, Python, C, C++, C#, JAVA, or any compiled or interpreted programming language.

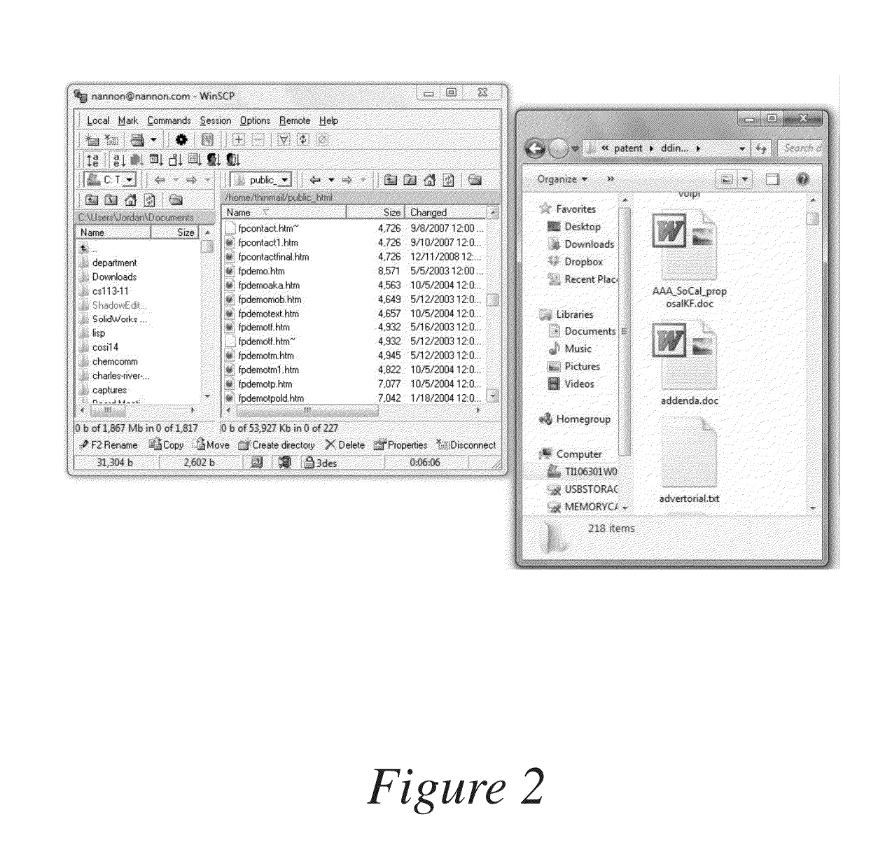

FIG. 2 shows a screenshot of the traditional way to upload and download files from a cloud storage system using a local machine such as a PC 8 running a GUI version of FTP or SCP.

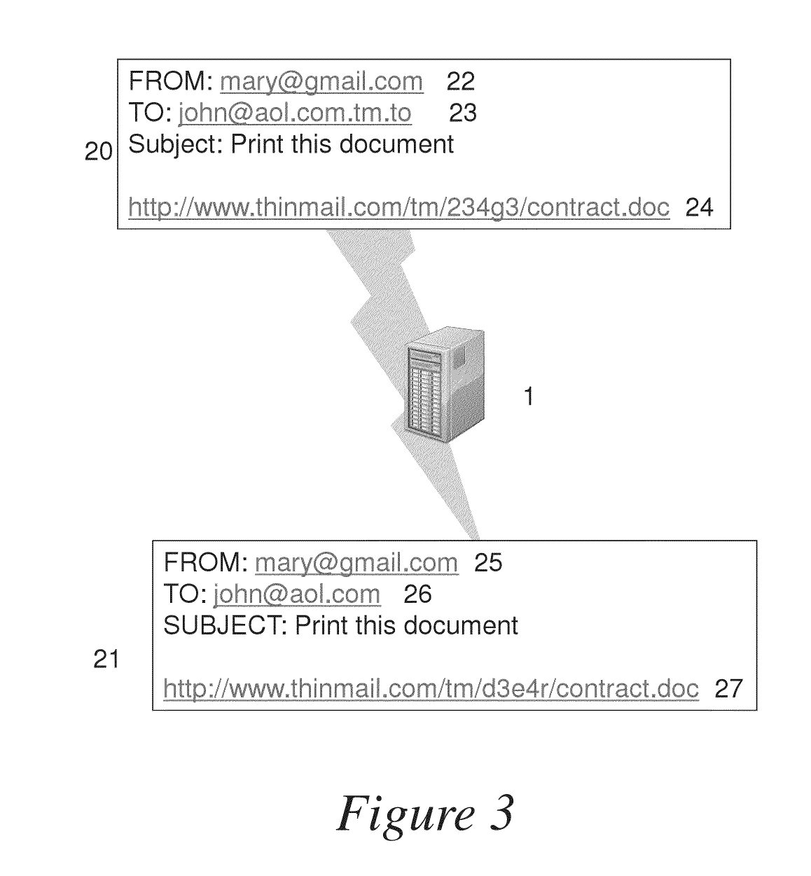

FIG. 3 shows the transformation of an email during transit from sender's viewpoint 20 to recipients viewpoint 21. The valid user mary@gmail.com who previously received a thinmail file handle (URL) wants to share it with John@aol.com, but not have the file spread virally. Her email contains her address 22 the recipients address with our short domain suffix 23, and a valid file handle 24 in the body of the email.

Looking at the recipient's message 21, John now has his own unique URL 27 to the shared file. After the first download, he must use his password to view or download the file. We note that the “FORWARD” command is not explicitly in the message header or body, but is implicit in the message 20 received by our server 1. Thus the current invention was not released for sale to the public nor disclosed in previous patent application.

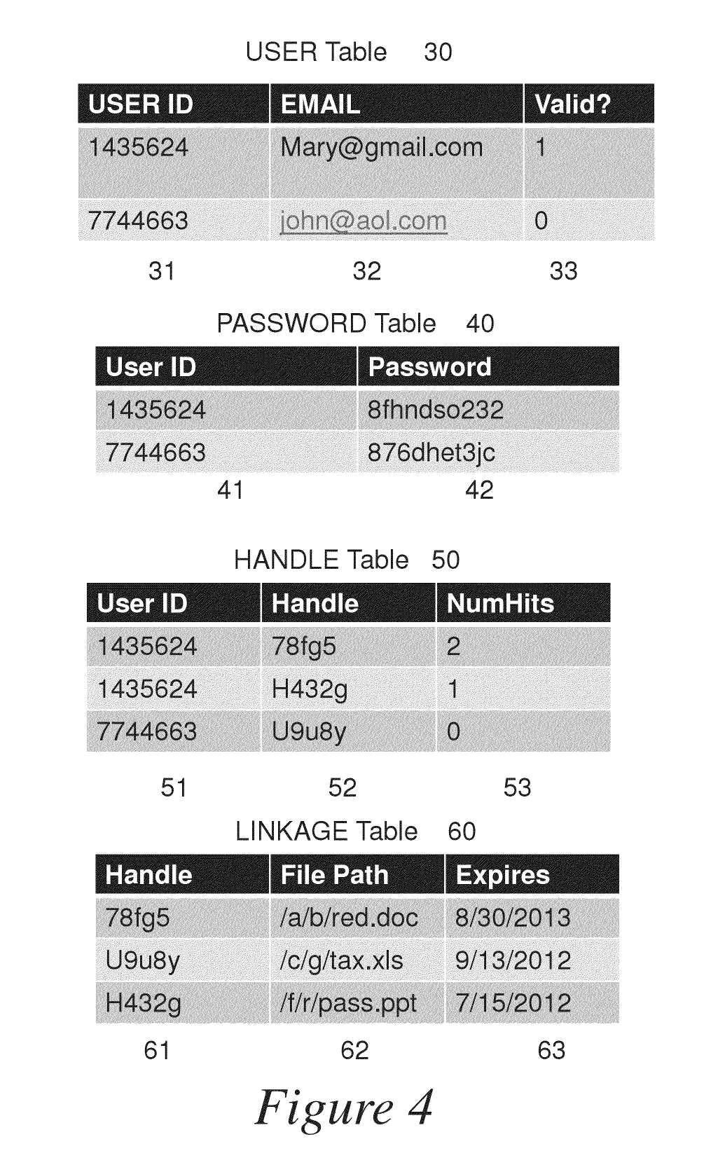

FIG. 4 shows simplified SQL tables used by this invention. The USER table 30 associates unique number codes 31 to email addresses 32 and whether the user has validated this login (e.g. by receiving a code from email) 33. A single UserID may have multiple email addresses (home, work, webmail, device mail, etc.)

The PASSWORD table 40 associates each UserID 41 with an encrypted password 42.

The HANDLE table 50 associates the UserID 51 with the file Handle 52 and tracks accesses 53 to be able to block copyright piracy via promiscuous sharing.

The LINKAGE table 60 is most important as it holds the list of Handles 61 associated to files paths 62 on the server 1 (or server farm, supercomputer, storage facility). Every legitimate handle points to a file which has not expired. Many users might have rights to access the same file, and in the LINKAGE table, each individual has their own unique handle to said file. Each handle may have its own expiration date 63, enabling the system to perform garbage collection on the file store.

At his smartphone, a user Joe@hotmail.com receives an email with a link to a LOMB powerpoint (PPT) file as taught by U.S. Pat. No. 6,505,236. He can click to open the file with an “app” like documents-to-go, but he knows it will cost him $3 because of his data plan. He wants to forward it to his colleague to print, but thinks he cannot do that without paying $6 for the privilege. So, all he has to do is forward the handle “through” our server by adding the short domain 6 to his colleagues email, e.g. peter@gmail.com.TM.TO.

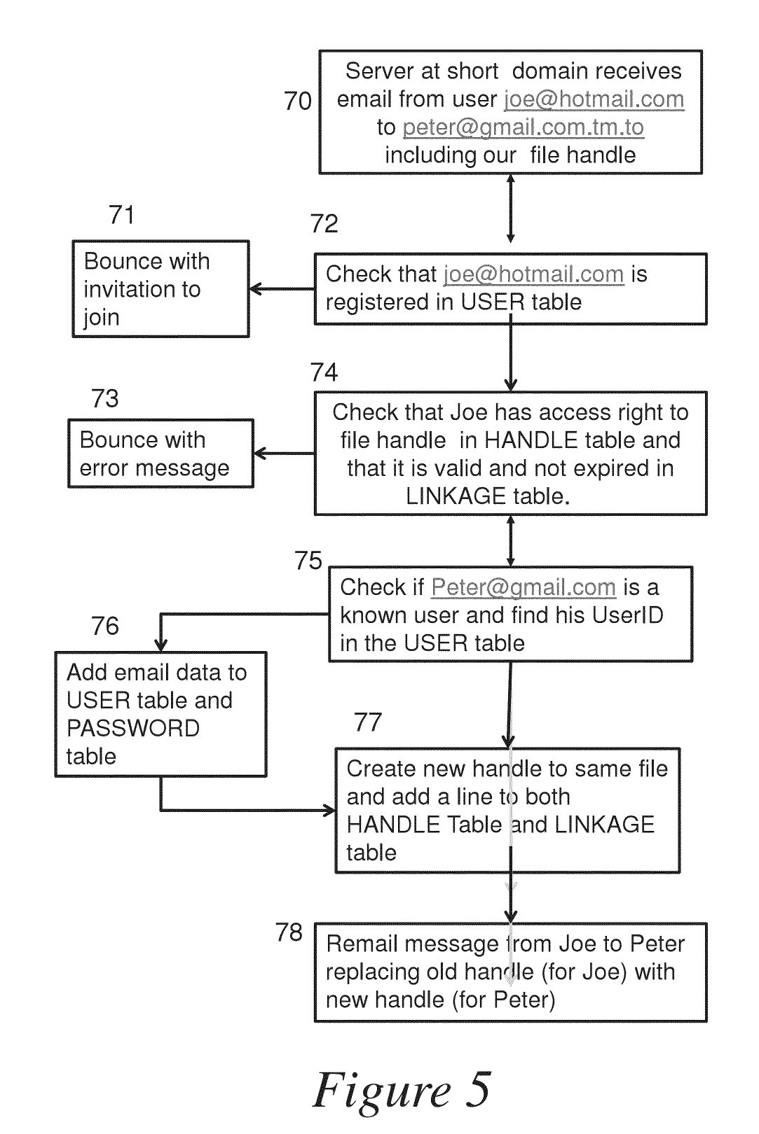

FIG. 5 explains the forwarding process and method in detail. Because the short domain's MX record in the DNS system resolves to our server 1, we receive the email 70, we check 72 that we know the sender and can bounce an error 71 if he is unknown.

Then we check that the handle is valid 74 and that the UserID for the sender has the right to access it using the USER and HANDLE tables, and bounce 73 if necessary.

Next, we look up the recipient's UserID 75. If email address is unknown, we create an unverified UserID and initial password, and send email to the new user with this information 76. We add 77 a line to the LINKAGE table for the new handle to the existing file, as well as to the HANDLE table 50.

Finally, our method issues 78 the email from Joe to Peter with the new handle in place of the old one.

When Peter opens the link, he increments the download count 53 from 0 to 1. Even if he published the link, other people will not be able to download the file Joe only shared with Peter.

Having described certain embodiments of methods and systems for utilizing a short domain for remailing to privately share files stored in a cloud based server, it will now become apparent to one of skill in the art that other embodiments incorporating the concepts of the disclosure may be used. Therefore, the disclosure should not be limited to only certain embodiments.

Thus we claim:

1) A process for performing identified modifications of content in an e-mail message at a server or server farm electronically distal from an e-mail origin site comprising:
a) the distal server or server farm being pointed to by an MX record of a short domain in the domain name server system being recognized by execution of code in a processor;
b) the e-mail origin site sending an e-mail message comprising a recipient e-mail address combined with said short domain as a suffix to a message receiving site.
c) the distal server or server farm then executing computation on said email message before it reaches a recipient e-mail address at the message receiving site, execution of code by the distal server or server farm resulting in
d) a modified e-mail message being forwarded on to said recipient e-mail address.

2) The process of claim 1 wherein a modification is performed on the e-mail message en route between sending and delivering the e-mail message.

3) The process of claim 1 wherein the modification is an arbitrary process performed by the server or server farm which enables the provision of arbitrary computer services applied to email messages en route.

4) A server or server farm in the cloud that executes code on transported e-mails by executing code on remailing software that creates new handles or new URL's for each recipient of a messageoriginally containing valid URL's to files stored in the server or server farm, the new handles or new URL's enabling each recipient of email to have their own value URL to said files.

5) A process or method running on a storage device or file system in the cloud which remails email messages from a known user comprising only 2 elements
a) A TO: address combines the email address of the recipient with our short domain
b) A valid handle to a file stored in our server or serverfarm

6) The process or method of claim 2 located on a server using the remailing process with a short domain suffix described in claim 1.

7) The process or method of claim 3 triggered by messages received at the server or serverfarm indicated by the MX record of the short domain suffix described in claim 1.

8) The short-domain remailer of claim 1 which blocks spam by execution of computation by the distal server or server farm.

9) The short-domain remailer of claim 1 which translates between human languages applied to email enroute by execution of computation by the distal server or server farm.
